(19) United States
(12) Patent Application Publication
(10) Pub. No.: US 2004/0098421 A1
(43) Pub. Date: May 20, 2004

(54) Scheduling updates of electronic files

(76) Inventor: Luosheng Peng, Alviso, CA (US)

Correspondence Address: Shemwell Gregory & Courtney LLP, Suite 201, 4880 Stevens Creek Boulevard, San Jose, CA, 95129, US

(21) Appl. No.: 10/298,862

(22) Filed: Nov. 18, 2002

(51) Int. Cl. G06F 12/00

(52) U.S. Cl. 707/203

(57) ABSTRACT

In scheduling updates of original electronic files, an upgrade system receiving new electronic files generates target lists of host device models/users that are to receive the new file information. The new file information includes upgrades and/or upgrade notifications. In response to the target lists, the upgrade system uses delivery rules to generate a delivery schedule for delivery of the information to the devices. The upgrade system executes a network traffic simulation using the delivery schedule. The simulation applies the delivery schedule to the network in order to estimate the network traffic capacity that would result from transferring the new file information in accordance with the delivery schedule. The upgrade system refines the delivery schedule, using results of the simulation, in order to optimize network performance. The upgrade system transmits the new file information to the appropriate devices in accordance with the refined delivery schedule.

### RELATED APPLICATIONS

This application is related to the application titled BYTE-LEVEL FILE DIFFERENCING AND UPDATING ALGORITHMS, application Ser. No. 10/146,545, filed May 13, 2002, the application titled UPDATING ELECTRONIC FILES USING BYTE-LEVEL FILE DIFFERENCING AND UPDATING ALGORITHMS, application Ser. No. 10/261,153, filed Sep. 30, 2002, the application titled UPGRADING OF ELECTRONIC FILES INCLUDING AUTOMATIC RECOVERY FROM FAILURES AND ERRORS OCCURRING DURING THE UPGRADE, Attorney Docket Number DOGO.P005 (Application Number not yet assigned), filed Nov. 12, 2002, the application titled DEVICE MEMORY MANAGEMENT DURING ELECTRONIC FILE UPDATING, Attorney Docket Number DOGO.P003 (Application Number not yet assigned), filed Nov. 18, 2002, the application titled GENERATING DIFFERENCE FILES USING MODULE INFORMATION OF EMBEDDED SOFTWARE COMPONENTS, Attorney Docket Number DOGO.P004 (Application Number not yet assigned), filed Nov. 18, 2002, the application titled CONTROLLING UPDATES OF ELECTRONIC FILES, Attorney Docket Number DOGO.P006 (Application Number not yet assigned), filed Nov. 18, 2002, and the application titled MANAGING ELECTRONIC FILE UPDATES ON CLIENT DEVICES, Attorney Docket Number DOGO.P008 (application No. not yet assigned), filed Nov. 18, 2002, all of which are currently pending.

### TECHNICAL FIELD

The disclosed embodiments relate to updating and maintaining electronic files.

### BACKGROUND

Software running on a processor or central processing unit (CPU) to provide functionality in the host device often changes over time. The changes may result from the need to correct bugs, or errors, in the software files, adapt to evolving technologies, or add new features. In particular, embedded software components hosted on mobile wireless devices often include numerous software bugs that require correction.

Software includes one or more files in the form of human-readable American Standard Code for Information Interchange (ASCII) plain text files or binary code. Software files can be divided into smaller units that are often referred to as modules or components. A UNIX platform or personal computer (PC) includes multiple software components, and each of the software components is managed and updated independently through a file system supported by a corresponding operating system (OS). Information used to update software files or software components hosted on UNIX platforms or PCs can be transferred through the Internet or loaded from a secondary storage medium such as a floppy disk, a compact disk read-only memory (CD-ROM), or a compact flash card.

In contrast, in mobile wireless devices, a real-time operating system (RTOS) is typically used in which all software components are linked as a single large file. Further, no file system support is typically provided in these mobile wireless devices. In addition, the single large file needs to be preloaded, or embedded, into the device using a slow communication link like a radio, infrared, or serial link.

Obstacles to updating the large files of mobile wireless devices via slow communication links include the time, bandwidth, and cost associated with delivering the updated file to the device. Distribution of such large files can take an undesirably long time from the point of view of the customer and can consume a large amount of server resources from the point of view of the file provider. Delivering a large file over an unreliable communication link such as a radio link may also increase the rate of communication failure and require a large working memory within the device, for example random access memory (RAM).

One solution to the problem of delivering large files to mobile devices for use in updating files of the mobile devices uses difference programs to generate difference files. The difference files include data that describes how a revised file differs from an original file. While use of the various difference programs helps reduce the size of the transferred files, network traffic management issues remain because the service provider or software provider has many subscribers or customers to which they must potentially provide updated files including difference files.

Generally, the number of subscribers supported by a service provider along with bandwidth limitations of the associated network prohibits timely updates of all files on all subscriber devices each time a new update becomes available. However, the service provider does have to ensure that particular updates (e.g., bug fixes) to particular files are distributed in a timely fashion. Therefore, even when using difference files to reduce the network bandwidth requirements per file transfer, the service provider is faced with managing the delivery of software upgrades to large numbers of supported users.

### BRIEF DESCRIPTION OF THE FIGURES

FIG. 1 is a block diagram of a file upgrade system including a traffic manager for scheduling file upgrades, under an embodiment.

FIG. 2 is a block diagram of an example service provider infrastructure including components of the file upgrade system of an embodiment.

FIG. 3 is a flow diagram for scheduling file upgrades using the traffic manager, under an embodiment.

FIG. 4 is a block diagram of a traffic manager and database for use in scheduling the delivery of file upgrade information, under the upgrade system embodiments of FIGS. 1 and 3.

FIG. 5 is a flow diagram for scheduling file upgrades using preference and/or usage information, under an alternative embodiment.

FIG. 6 is a block diagram of a traffic manager and database for use in scheduling the delivery of file upgrade information using preference and/or usage information, under the upgrade system embodiments of FIGS. 1 and 5.

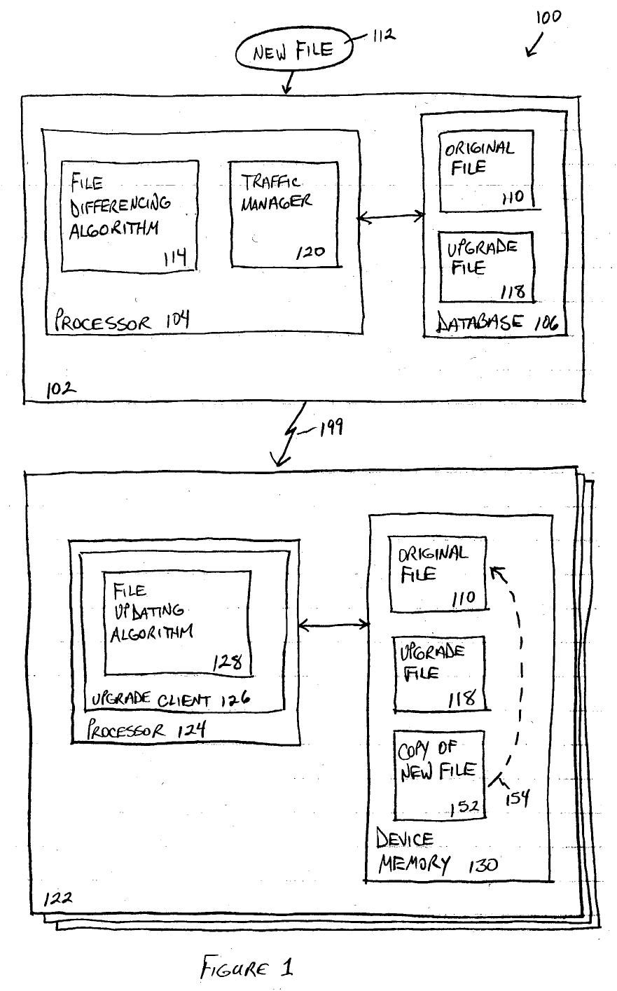

In the drawings, the same reference numbers identify identical or substantially similar elements or acts. To easily identify the discussion of any particular element or act, the most significant digit or digits in a reference number refer to the Figure number in which that element is first introduced (e.g., element 116 is first introduced and discussed with respect to FIG. 1).

Unless described otherwise below, the construction and operation of the various blocks and structures shown in the Figures are of conventional design. As a result, such blocks need not be described in further detail herein, because they will be understood by those skilled in the relevant art. Such further detail is omitted for brevity and so as not to obscure the detailed description of the invention. Any modifications necessary to the Figures can be readily made by one skilled in the relevant art based on the detailed description provided herein.

### DETAILED DESCRIPTION

A system and associated methods are provided below for controlling the delivery of electronic file upgrade information to host devices like, for example, mobile devices. The upgrade system allows for scheduling upgrades and/or upgrade notifications based on pre-defined and dynamically generated user groups to facilitate traffic management control. The upgrade system uses traffic rules and a traffic simulator to develop and refine notification schedules, thereby optimizing network performance during delivery of the upgrade information.

In the following description, numerous specific details are introduced to provide a thorough understanding of, and enabling description for, embodiments of the invention. One skilled in the relevant art, however, will recognize that the invention can be practiced without one or more of the specific details, or with other components, systems, etc. In other instances, well-known structures or operations are not shown, or are not described in detail, to avoid obscuring aspects of the invention.

In scheduling updates of original electronic files, an upgrade system receiving new electronic files generates target lists of host device models/users that are to receive the new file information. The new file information includes upgrades and/or upgrade notifications. In response to the target lists, the upgrade system uses delivery rules to generate a delivery schedule for delivery of the information to the devices. The upgrade system executes a network traffic simulation using the delivery schedule. The simulation applies the delivery schedule to the network in order to estimate the network traffic capacity that would result from transferring the new file information in accordance with the delivery schedule. The upgrade system refines the delivery schedule, using results of the simulation, in order to optimize network performance. The upgrade system transmits the new file information to the appropriate devices in accordance with the refined delivery schedule.

FIG. 1 is a block diagram of a file upgrade system 100 including a traffic manager 120 for scheduling file upgrades, under an embodiment. Generally, the file upgrade system 100 includes a first computer system 102 and one or more second computer systems 122 communicating via a communication path 199. These computer systems 102 and 122 include any collection of computing devices operating together, as is known in the art. The computer systems 102 and 122 also include components within a larger computer system. The communication path 199 includes any medium for communicating or transferring files among the computer systems 102 and 122. Therefore, this path 199 includes wireless connections, wired connections, and hybrid wireless/wired connections. The communication path 199 also includes couplings or connections to networks including local area networks (LANs), metropolitan area networks (MANs), wide area networks (WANs), proprietary networks, interoffice or backend networks, and the Internet. Furthermore, the communication path 199 includes removable fixed mediums like floppy disks, hard disk drives, and CD-ROM disks, as well as flash RAM, Universal Serial Bus (USB) connections, RS-232 connections, telephone lines, buses, and electronic mail messages.

The first 102 and second 122 computer systems each include an original version 110 of an electronic file, referred to herein as the original file 110. The first computer system 102 stores the original file 110 in a database 106 or other memory area or combination of memory areas or devices, but is not so limited. The second computer system 122 stores the original file 110 in device memory for use in operation.

At such time as a software provider upgrades the original file 110, for example to provide additional functionality or to fix a software bug, a new version 112 of the electronic file is generated. The new version 112 of the electronic file is referred to herein as the new file 112. The new file 112 is generally an updated or revised version of the original file 110, but is not so limited. The software provider transfers the new file 112 to the first computer system 102.

The electronic files 110 and 112 include software files including dynamic link library files, shared object files, embedded software components (EBSCs), firmware files, executable files, data files including hex data files, system configuration files, and files including personal use data, but are not so limited. Since any type of file can be regarded as a byte stream, hereafter a file can be described as a byte stream.

Components of the first computer system 102 including at least one processor 104 receive and process the new file 112 in order to generate upgrade information for use in upgrading the hosted original files 110 of the second computer system 122. In an embodiment, the processor 104 generates an upgrade file 118 for use in transferring information of the upgrades to the second computer systems 122.

The upgrade file 118 can include a difference file that codes differences between the new file 112 and the original file 110 or, alternatively, can include any number and/or combination of components or modules of the new file 112. In embodiments where the upgrade file 118 includes a difference file, components of the first computer system 102 including the processor 104 and the file differencing algorithm 114 process a comparison between the new file 112 and the corresponding original file 110, thereby calculating the differences between the new file 112 and the original file 110. The file differencing algorithm 114 generates the difference file during the comparison and writes the difference file to the upgrade file 118.

The processor 104 uses traffic rules and a traffic simulator of the traffic manager 120 to develop and refine notification schedules, thereby optimizing network performance during delivery of the upgrade information. Components of the first computer system 102 provide the upgrade information to the second computer systems 122, in accordance with the notification schedules, via transfer of the upgrade file 118 over the communication path 199. Prior to transfer, the upgrade file 118 may be compressed using any of a number of compression techniques known in the art, but is not so limited.

Components of the second computer system 122 including the processor 124 and the upgrade client 126 receive the upgrade file 118 and control the upgrade of the original file using the upgrade file 118. In an embodiment, the upgrade client 126, including the file updating algorithm 128, processes information of the upgrade file 118 along with the hosted original file 110 to generate a copy of the new file 152. This copy of the new file 152 is subsequently used by the upgrade client 126 to upgrade 154 the targeted original file 110 hosted on the client device 122. The upgrade client 126 of an embodiment uses numerous methods to update EBSCs depending on the file type to be updated and the resources allocated by the client device manufacturer to support these updates, as described in the Related Applications. Upon completion of this update process, the original file 110 now stored on the second computer system 122 is the same as the new file 112 received in the first computer system 102.

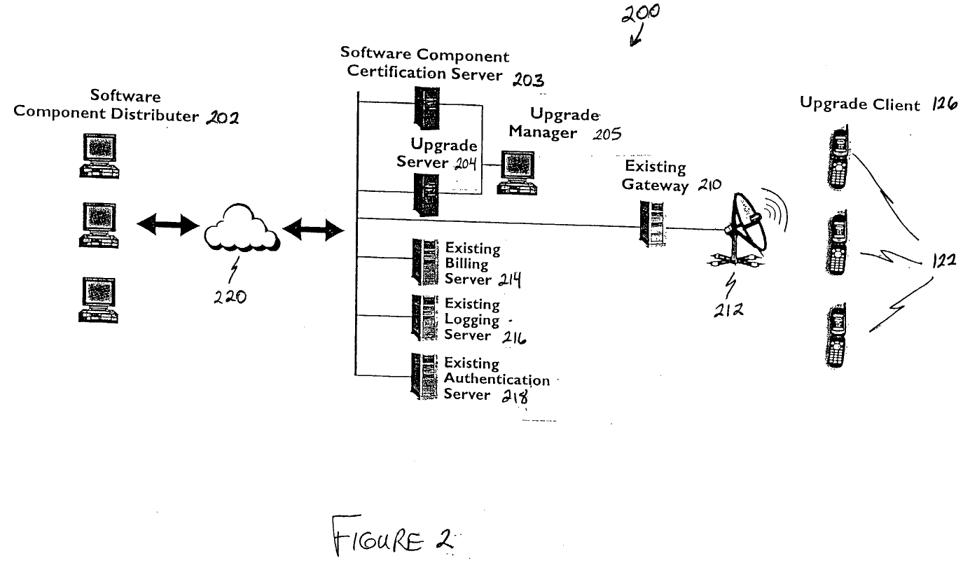

FIG. 2 is a block diagram of an example service provider infrastructure 200 including components of the file upgrade system 100 of an embodiment. In this embodiment the service provider infrastructure is described in the context of a cellular telephone network or infrastructure, but alternative embodiments are not so limited. The service provider infrastructure 200 includes, but is not limited to, a Software Component Distributor (SCD) 202, service provider upgrade components 203-205, and an upgrade client 126 hosted on the client devices 122. The service provider upgrade components 203-205 include an upgrade server 204 coupled among a software component certification server 203 and an upgrade manager 205.

With further reference to FIG. 1, the SCD 202 of an embodiment of the service provider infrastructure 200 includes components or functions of the first computer system 102. In alternative embodiments, the service provider upgrade components 203-205 host components or functions of the first computer system 102. In other alternative embodiments the components or functions of the first computer system 102 are distributed among components of the SCD 202 and the service provider upgrade components 203-205.

The service provider infrastructure 200 of an embodiment supports numerous types of software file or component upgrades on client devices 122 including mobile electronic devices, mobile communication devices, cellular telephones, personal digital assistants, computers, and other processor-based devices via the upgrade system components and various mechanisms of the service provider's wireless infrastructure. These systems function by receiving new and revised software from a software distributor, generating an upgrade file from the new software, and transferring the upgrade file to the client device 122 via the service provider infrastructure. The upgrade client 126 of the receiving or client device 122 uses the upgrade file to update the targeted software hosted on the client device 122.

The SCD 202 of an embodiment provides a user interface by which software providers package and release new embedded device software components. Functions of the SCD 202 include registering device information and submitting device information to the software component certification server. Also, the SCD 202 receives new and original EBSCs, calculates or generates file differences using the new and original EBSCs, registers and packages embedded software, and submits embedded software packages to the software component certification server 203. The new or revised software, following release, is provided to the service provider upgrade components 203-205 via a wired, wireless, or hybrid wired/wireless network coupling or connection 220, but is not so limited.

The SCD 202 of an embodiment is hosted on processing systems of the client device manufacturers. In an alternative embodiment, the SCD 202 is hosted on processing systems of an application or system software provider. In another alternative embodiment, the SCD 202 is hosted on processing systems of the service carrier or provider, for example hosted on or distributed among the upgrade components 203-205.

The service provider upgrade components 203-205 are coupled among the software component distributor 202, the client devices 122, and the existing components of the service provider's infrastructure 210-218, including the existing gateway 210 and communication infrastructure 212, billing server 214, logging server 216, and authentication server 218.

The software component certification server 203 provides an interface to the manufacturers of client devices and, thus, receives new device information on embedded software packages from device manufacturers. The software component certification server 203 also repackages and distributes approved software packages to upgrade servers.

The upgrade manager 205, while functioning as an interface among the software component certification server 203 and the upgrade server 204, configures software and data packaging for optimal device management, schedules remote change notifications, and controls the update policy monitor system. Moreover, the upgrade manager 205 provides integration with the systems of the existing infrastructure.

The upgrade server 204 provides capabilities including authenticating, connecting, and communicating with mobile client devices 122 to perform embedded software component upgrades. Communication with client devices 122 can occur via couplings 212 with the client devices 122 that include wireless couplings, wired couplings, hybrid wired/wireless couplings, and other network coupling types, as appropriate to the corresponding service provider. In addition, the upgrade server 204 supports existing billing, data collection, and logging services of the service provider.

As an example of communications among the upgrade server 204 and client devices 122, when an upgrade file is available for transfer to a client device 122 from the upgrade server 204, the server 204 sends a user notification to notify the client device user that there are software components available for updating. The user notification is transmitted in accordance with the schedules generated by components of the traffic manager 120. The user notification can take the form of a text message via a Short Message Service (SMS) push protocol, Hypertext Transfer Protocol (HTTP), or Wireless Application Protocol (WAP), but is not so limited. Upon receiving confirmation from the handset users, the upgrade server 204 uses the original handset data communication protocol to send the upgrade file to the requesting handset.

In response to receipt of the confirmation from the handset, the upgrade server 204 authenticates and authorizes the user and/or requesting device, and verifies prerequisite capabilities and limitations of the requesting device. Following authentication the upgrade server 204, as the manager of client device configuration data, identifies the current versions of embedded software components of the requesting device 122, identifies and transfers appropriate upgrade files to the requesting device 122, logs the status of the upgrade transaction, and reports the results to the upgrade manager 205.

The service providers of an embodiment, in providing software updates to client devices, use control policies to effectively manage the network capacity and control issues associated with the distribution of upgrade files to large numbers of users. These update control policies control the launch and execution of associated file upgrades, and are determined and assigned by the service provider. While many update control policies and combinations of policies are possible, two particular policies include an automatic update control policy and a user-selected update control policy. The automatic update supports the automatic updating of files on the client device without any action from the device user, while the user-selected update launches an update in response to some action by the device user. Any number/combination of or other update control policies may be used as recognized by one skilled in the art.

While the update control policies help a service provider control delivery of upgrades, network traffic management tools of an embodiment provide the capability to efficiently manage the flow of large volumes of communications associated with the remote upgrade of large numbers of users or subscribers. In addition, the network traffic management tools support the service providers in providing effective service including the delivery of upgrades and the provision of additional device capability in accordance with user preferences.

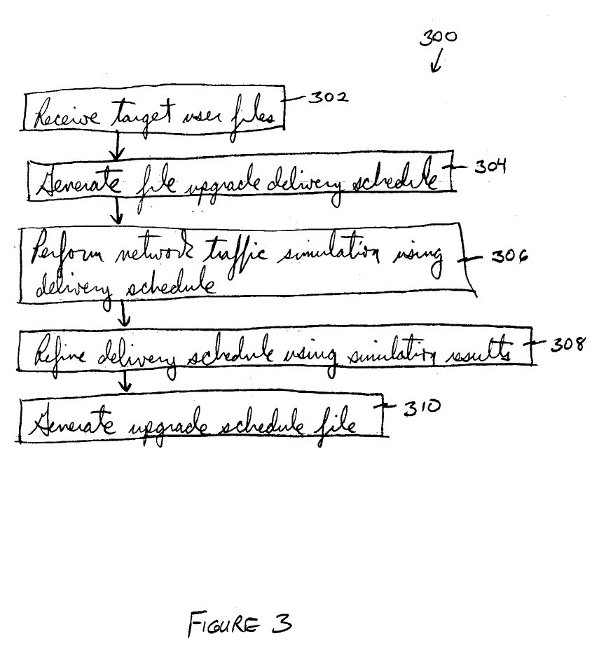

FIG. 3 is a flow diagram 300 for scheduling file upgrades using the traffic manager, under an embodiment. The upgrade system of an embodiment receives a new file or an upgrade file, as described above, and generates at least one target list or group including these users. Each target list or group is associated with an update control policy, but the embodiment is not so limited. Furthermore, each target list or group can be associated with a priority. Upon generation or receipt of these target lists, at block 302, the upgrade system generates a delivery schedule for delivery of the new file information to the devices of the target lists, at block 304. The new file information includes upgrades and/or upgrade notifications associated with the new file, but is not so limited.

The upgrade system executes a network traffic simulation using the delivery schedule, at block 306. The traffic simulation applies the delivery schedule to current information of the network traffic status in order to estimate or predict the network traffic status that would result from transferring the new file information according to the delivery schedule. The upgrade system refines or adjusts the delivery schedule, as appropriate, using results of the simulation, at block 308. The refinement allows the upgrade system to optimize network performance during delivery of the new file information. The upgrade system generates an upgrade schedule file, at block 310, and transmits the new file information to the appropriate devices in accordance with information of the upgrade schedule file.

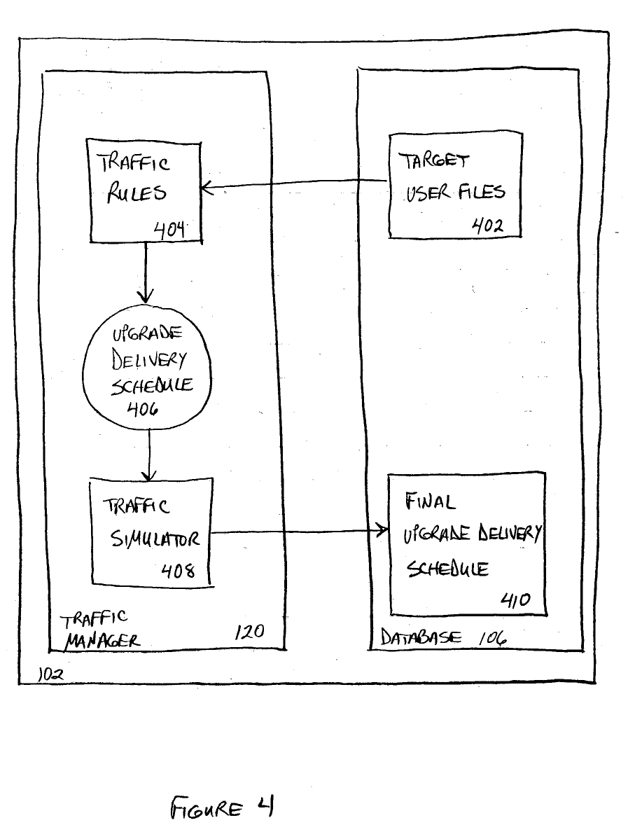

FIG. 4 is a block diagram of a traffic manager 120 and database 106 for use in scheduling the delivery of file upgrade information, under the upgrade system embodiment of FIG. 1. Components of the traffic manager 120 include a traffic rules module 404, including traffic rules, and a traffic simulator module 408, including a traffic simulator or simulation algorithm.

In operation, the traffic rules module 404 receives information of the target user files 402. The information of the target user files 402 can be coupled to the traffic rules module 404 from the database 106 or from other components of the first computer system 102. The traffic rules module 404 functions to apply at least one set of traffic rules to the target user file information and generate an upgrade delivery schedule 406. The traffic rules include, for example, rules that limit the channel bandwidth to a pre-determined level for each transmission time slot, but rules of any network control scheme are contemplated for use by the traffic rules module 404. The upgrade delivery schedule can be prioritized to correspond to a prioritized target user file, but the embodiment is not so limited.

Components of the first computer system 102 transfer the upgrade delivery schedule 406 to the traffic simulator module 408. Upon generation, the upgrade delivery schedule 406 can also be stored in the database 106, for example, but the embodiment is not so limited.

The traffic simulator module 408 runs a network traffic simulation that predicts traffic flow across the network using the upgrade delivery schedule 406. In so doing, the simulation applies the upgrade delivery schedule 406 to a current traffic status of the network in order to estimate the network traffic capacity that would result from transferring the new file information in accordance with the delivery schedule. The traffic simulator module 408 of an embodiment generates a network capacity graph that plots predicted network capacity or bandwidth versus time for the delivery schedule, but other embodiments can provide any number of outputs from the traffic simulator module 408.

The traffic manager 120 refines or adjusts the delivery schedule, using results of the simulation, in order to optimize network performance. The adjustments can include moving target users among the available transmission time intervals in order to optimize network performance in one or more of the transmission time intervals; however, any known method of adjusting the delivery schedule to optimize network performance is contemplated by the traffic manager 120. Various embodiments and alternative embodiments can refine the delivery schedule using any number/combination of components of the first computer system 120. For example, the traffic simulator module 408 can generate the final upgrade delivery schedule 410, while other alternative embodiments transfer the simulation results to the traffic rules module 404 where the final upgrade delivery schedule is generated. In another alternative embodiment, the first computer system 102 regenerates the target user files using the simulation results.

Components of the traffic manager 120 transfer the final upgrade delivery schedule 410 to the database 106 where it is stored, but the embodiment is not so limited. Alternative embodiments of the traffic manager 120 may not store the final upgrade delivery schedule 410 in the database or may store the final upgrade delivery schedule in another location or memory device. The upgrade system transmits the new file information to the appropriate devices in accordance with the final upgrade delivery schedule 410.

The first computer system 102 can tailor the final upgrade delivery schedule using information of the service provider database or information gathered from users to filter the target user files and generate subgroups of the files to which the traffic rules are applied. As an example, the first computer system 102 uses user preference data and actual usage data of a file, alone or in some combination, to generate tailored final upgrade delivery schedules.

The service provider gathers the user preference data from users in any number of ways known in the art. For example, the service provider can gather the data by allowing a user to log into a World Wide Web (“web”) site, via the client device or another processor-based device, and select their individual preferences which are then stored in the service provider database where they are associated with the user's account. Alternatively, the service provider gathers the preference information incrementally by providing electronic queries to user's via the client devices.

Regarding the actual usage information, the service provider can gather actual usage data for applications running on the client device via the service provider network couplings to the client device. The usage information includes information as to the number of times a user access a program or file and the amount of time applications are in use, for example.

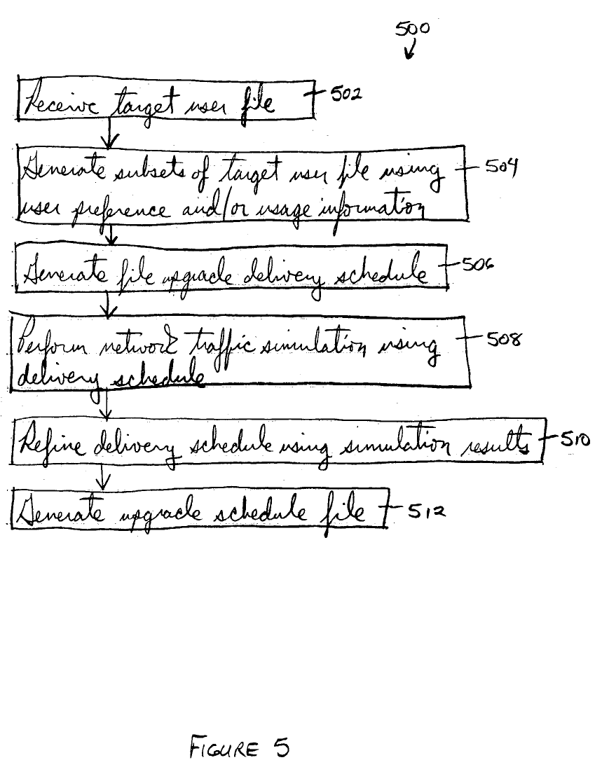

FIG. 5 is a flow diagram 500 for scheduling file upgrades using preference and/or usage information, under an alternative embodiment. The upgrade system of an embodiment receives a new file or an upgrade file, as described above, and generates at least one target list or group including these users. Upon receipt of these target lists, the upgrade system generates subgroups of the target lists, at block 504, using preference and/or usage information associated with the users on the lists. The preference and/or usage information includes preferences received from users, information of actual usage of client device files, or combinations of the preference and usage information. At block 506, the upgrade system generates a delivery schedule for delivery of the new file information to the devices of the target list subgroups. The new file information includes upgrades and/or upgrade notifications associated with the new file, but is not so limited.

The upgrade system executes a network traffic simulation using the delivery schedule, at block 508. The traffic simulation applies the delivery schedule to the current network traffic status in order to estimate the network traffic capacity that would result from transferring the new file information according to the delivery schedule. The upgrade system refines or adjusts the delivery schedule, as appropriate, using results of the simulation, at block 510. The adjustments allow the upgrade system to optimize network performance during delivery of the new file information. The upgrade system generates an upgrade schedule file, at block 512, and transmits the new file information to the appropriate devices in accordance with information of the upgrade schedule file.

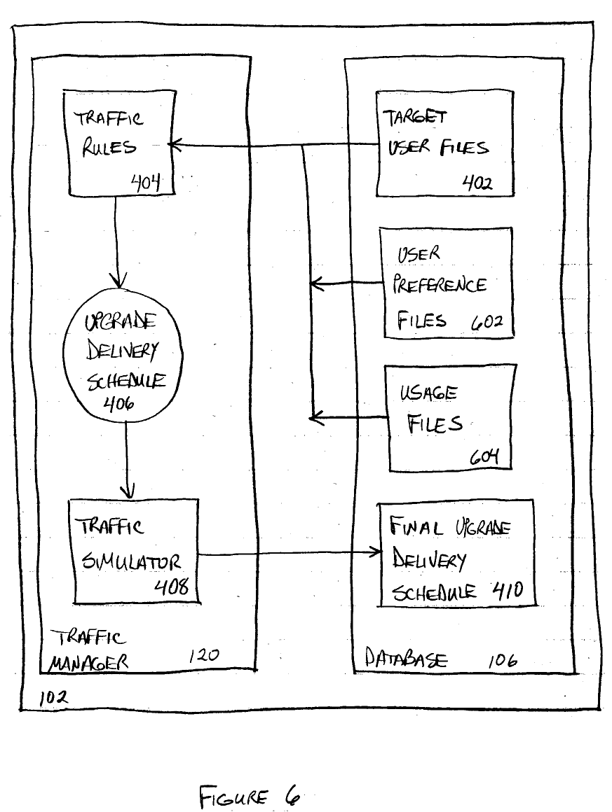

FIG. 6 is a block diagram of a traffic manager 120 and database 106 for use in scheduling the delivery of file upgrade information using preference and/or usage information, under an alternative embodiment of FIG. 4. Components of the traffic manager 120 include a traffic rules module 404 and a traffic simulator module 408.

In operation, the traffic rules module 404 receives information of the target user files 402. The information of the target user files 402 can be coupled to the traffic rules module 404 from the database 106 or from other components of the first computer system 102. Additionally, the traffic rules module 404 receives at least one of user preference information from the user preference file 602, usage information from the usage file 604, and some combination of user preference information and usage information. The traffic rules module 404 generates subgroups of the target user files using the preference and/or usage information. In alternative embodiments, components of the first computer system 102 other than the traffic rules module 404 receive the preference and/or usage information and generate the target user subgroups.

Following generation of the target user subgroups, the traffic rules module 404 applies at least one set of traffic rules to the target user subgroups and generates an upgrade delivery schedule 406, as described above. Components of the first computer system 102 transfer the upgrade delivery schedule 406 to the traffic simulator module 408. Upon generation, the upgrade delivery schedule 406 can be stored in the database 106, for example, but the embodiment is not so limited.

The traffic simulator module 408 runs a network traffic simulation using the upgrade delivery schedule 406. The simulation applies the upgrade delivery schedule 406 to the network parameters in order to estimate the network traffic capacity that would result from transferring the new file information in accordance with the delivery schedule. The traffic simulator module 408 of an embodiment generates a network capacity graph that plots network capacity or bandwidth versus time for the delivery schedule, but other embodiments can provide any number of outputs from the traffic simulator module 408.

The traffic manager 120 refines or adjusts the delivery schedule, using results of the simulation, in order to optimize network performance. The adjustments can include moving target users among the available transmission time intervals in order to optimize network performance, but any known method of adjusting the delivery schedule to optimize network performance is contemplated by the traffic manager 120. Various embodiments and alternative embodiments can refine the delivery schedule using any number/combination of components of the first computer system 120.

Components of the traffic manager 120 transfer the final upgrade delivery schedule 410 to the database 106 where it is stored, but the embodiment is not so limited. Alternative embodiments of the traffic manager 120 may not store the final upgrade delivery schedule 410 in the database or may store the final upgrade delivery schedule in another location or memory device. The upgrade system transmits the new file information to the appropriate devices in accordance with the refined delivery schedule.

At the time the target user subgroups are generated using the preference and/or usage information, the service provider of an alternative embodiment can elect to assign a priority to each subgroup. The priority can be generated using the preference and/or usage information, but is not so limited. The priorities are based on the frequency of usage, the amount of usage, and strength-of-preference information, to name a few. When using priorities, the traffic manager 120 assigns an upgrade schedule to each target user subgroup in accordance with the priorities of the subgroups. For example, the traffic manager 120 places a subgroup with a higher priority earlier in the transmission schedule. Alternatively, the traffic manager 120 places a subgroup with a lower priority earlier in the transmission schedule.

Aspects of the invention may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the invention include: microcontrollers with memory (such as electronically erasable programmable read only memory (EEPROM)), embedded microprocessors, firmware, software, etc. Furthermore, aspects of the invention may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” and words of similar import, when used in this application, shall refer to this application as a whole and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other processing systems and communication systems, not only for the file updating described above.

The elements and acts of the various embodiments described above can be combined to provide further embodiments. These and other changes can be made to the invention in light of the above detailed description.

All of the above references and United States patents and patent applications are incorporated herein by reference. Aspects of the invention can be modified, if necessary, to employ the systems, functions and concepts of the various patents and applications described above to provide yet further embodiments of the invention.

In general, in the following claims, the terms used should not be construed to limit the invention to the specific embodiments disclosed in the specification and the claims, but should be construed to include all processing systems that operate under the claims to provide a method for file differencing and updating. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

What I claim is:

1. A system for upgrading electronic files, comprising:
a first device including at least one processor configured to,
receive a target list including host devices that are to receive a new electronic file that is an updated version of an original electronic file;
generate a first delivery schedule for delivery of the new electronic file to the host devices of the target list using a set of delivery rules;
execute a network traffic simulation for the first delivery schedule, wherein the network traffic simulation estimates a capacity of the network versus time corresponding to the first delivery schedule;
generate a second delivery schedule in response to results of the network traffic simulation, wherein the second delivery schedule is a revision of the first delivery schedule that adjusts scheduled delivery to optimize network performance; and
control delivery of information of the new electronic file using the second delivery schedule; and
at least one host device receiving the information of the new electronic file from the first device via at least one coupling, wherein the host devices control the upgrading of the original electronic files of the hosted devices in response to the received information of the new electronic file.

2. The system of claim 1, wherein controlling delivery further comprises transmitting notification messages to the host devices of the target list using the second delivery schedule, wherein the notification messages include information of availability of the new electronic file.

3. The system of claim 1, wherein controlling delivery further comprises transmitting the new electronic file to host devices of the target list using the second delivery schedule.

4. The system of claim 1, wherein generating a first delivery schedule includes:
receiving user preference information;
generating subsets of the target list in accordance with the user preference information; and
generating the first delivery schedule by applying the set of delivery rules to the subsets of the target list.

5. The system of claim 1, wherein generating a first delivery schedule includes:
receiving usage information for the original electronic files of each host device;
generating subsets of the target list in accordance with the usage information; and
generating the first delivery schedule by applying the set of delivery rules to the subsets of the target list.

6. The system of claim 1, wherein generating a first delivery schedule includes:
receiving user preference information and usage information for the original electronic files of each host device;
generating subsets of the target list in accordance with the user preference and usage information; and
generating the first delivery schedule by applying the set of delivery rules to the subsets of the target list.

7. The system of claim 1, wherein the second device is at least one processor-based device selected from among personal computers, portable computing devices, cellular telephones, portable communication devices, and personal digital assistants.

8. The system of claim 1, wherein the at least one coupling is selected from among wireless couplings, wired couplings, hybrid wireless/wired couplings, and couplings to networks including local area networks (LANs), metropolitan area networks (MANs), wide area networks (WANs), proprietary networks, backend networks, the Internet, and removable fixed mediums including floppy disks, hard disk drives, and CD-ROM disks, as well as telephone lines, buses, and electronic mail messages.

9. The system of claim 1, wherein the original and new electronic files comprise software files including dynamic link library files, shared object files, embedded software components (EBSCs), firmware files, executable files, data files including hex data files, system configuration files, and files including personal use data.

10. The system of claim 1, wherein the new electronic file is at least one of a new version of the original electronic file and a difference file, wherein the difference file includes coded differences between the new electronic file and the original electronic file.

11. A method for controlling delivery of electronic file upgrades via a network, comprising:
receiving a target list including host devices that are to receive a new electronic file that is an updated version of an original electronic file;
generating a first delivery schedule for delivery of the new electronic file to the host devices of the target list using a set of delivery rules;
executing a network traffic simulation for the first delivery schedule, wherein the network traffic simulation estimates a capacity of the network versus time corresponding to the first delivery schedule;
generating a second delivery schedule in response to results of the network traffic simulation, wherein the second delivery schedule is a revision of the first delivery schedule that adjusts scheduled delivery to optimize network performance; and
controlling delivery of information of the new electronic file using the second delivery schedule.

12. The method of claim 11, wherein controlling delivery further comprises transmitting notification messages to the host devices of the target list using the second delivery schedule, wherein the notification messages include information of availability of the new electronic file.

13. The method of claim 12, wherein the notification messages correspond to an upgrade control policy.

14. The method of claim 11, wherein controlling delivery further comprises transmitting the new electronic file to host devices of the target list using the second delivery schedule.

15. The method of claim 1 1, wherein controlling delivery further comprises transmitting notification messages and the new electronic file to the host devices of the target list using the second delivery schedule, wherein the notification messages include information of availability of the new electronic file.

16. The method of claim 15, wherein the notification messages are appropriate to a user-selected upgrade control policy of receiving host devices, wherein the new electronic files are transmitted using the second delivery schedule upon receiving selection responses to the notification messages from users via the host devices.

17. The method of claim 11, wherein generating a first delivery schedule includes:
receiving user preference information;
generating subsets of the target list in accordance with the user preference information; and
generating the first delivery schedule by applying the set of delivery rules to the subsets of the target list.

18. The method of claim 11, wherein generating a first delivery schedule includes:
receiving usage information for the original electronic files of each host device;
generating subsets of the target list in accordance with the usage information; and
generating the first delivery schedule by applying the set of delivery rules to the subsets of the target list.

19. The method of claim 11, wherein generating a first delivery schedule includes:
receiving user preference information and usage information for the original electronic files of each host device;
generating subsets of the target list in accordance with the user preference and usage information; and
generating the first delivery schedule by applying the set of delivery rules to the subsets of the target list.

20. The method of claim 11, wherein the target list is a prioritized list and the first delivery schedule is in accordance with the priority of the target list.

21. The method of claim 11, wherein the new electronic file is at least one of a new version of the original electronic file and a difference file, wherein the difference file includes coded differences between the new electronic file and the original electronic file.

22. An apparatus that controls delivery of electronic file upgrades to a portable host device via a network, comprising:
means for receiving a target list including host devices that are to receive a new electronic file that is an updated version of an original electronic file;
means for generating a first delivery schedule for delivery of the new electronic file to the host devices of the target list using a set of delivery rules;
means for executing a network traffic simulation for the first delivery schedule, wherein the network traffic simulation estimates a capacity of the network versus time corresponding to the first delivery schedule;
means for generating a second delivery schedule in response to results of the network traffic simulation, wherein the second delivery schedule is a revision of the first delivery schedule that adjusts scheduled delivery to optimize network performance; and
means for controlling delivery of information of the new electronic file using the second delivery schedule.

23. The apparatus of claim 22, wherein the means for controlling delivery further comprises means for transmitting notification messages to the host devices of the target list using the second delivery schedule, wherein the notification messages include information of availability of the new electronic file.

24. The apparatus of claim 22, wherein the means for controlling delivery further comprises means for transmitting the new electronic file to host devices of the target list using the second delivery schedule.

25. The apparatus of claim 22, wherein the means for generating a first delivery schedule includes:
means for receiving at least one of user preference information and usage information for the original electronic files of each host device;
means for generating subsets of the target list in accordance with at least one of the user preference information and the usage information; and
means for generating the first delivery schedule by applying the set of delivery rules to the subsets of the target list.

26. A computer readable medium including executable instructions which, when executed in a processing system, control delivery of electronic file upgrades to a host device by:
receiving a target list including host devices that are to receive a new electronic file that is an updated version of an original electronic file;
generating a first delivery schedule for delivery of the new electronic file to the host devices of the target list using a set of delivery rules;
executing a network traffic simulation for the first delivery schedule, wherein the network traffic simulation estimates a capacity of the network versus time corresponding to the first delivery schedule;
generating a second delivery schedule in response to results of the network traffic simulation, wherein the second delivery schedule is a revision of the first delivery schedule that adjusts scheduled delivery to optimize network performance; and
controlling delivery of information of the new electronic file using the second delivery schedule.
